(19) United States
(12) Patent Application Publication
(10) Pub. No.: US 2016/0059534 A1
(43) Pub. Date: Mar. 3, 2016

(54) Joining via Slender Nanomaterials: Materials, Procedures and Applications Thereof

(71) Applicants: Anagi Manjula Balachandra, Okemos, MI (US); Parviz Soroushian, Oremos, MI (US)

(72) Inventors: Anagi Manjula Balachandra, Okemos, MI (US); Parviz Soroushian, Oremos, MI (US)

(73) Assignee: METNA CO, Lansing, MI (US)

(21) Appl. No.: 13/534,196

(22) Filed: Jun. 27, 2012

(51) Int. Cl. B32B 37/04; B29C 65/00; B29C 65/14; B29C 65/34; B32B 37/06; B32B 37/16

(52) U.S. Cl. CPC B32B 37/04; B32B 37/06; B32B 37/16; B29C 65/1438; B29C 65/3492; B29C 65/3408; B29C 66/3022; B29C 66/303; B29C 66/3494; B29C 66/45; B29C 66/71; B32B 2310/0862; B32B 2367/00; B32B 2323/10; B29K 2623/12; B29K 2667/003

(57) ABSTRACT

A method of joining two articles using slender nanomaterials is described. Randomly oriented nanomaterial mats or aligned nanomaterial arrays are introduced at the interface between the two articles followed by their energization via at least one of microwave irradiation and heating. The nanomaterial-to-nanomaterial and nanomaterial-to-surface contacts are enhanced by at least one of fusion, embedment and chemical reaction phenomena upon energization. The fusion, embedment and chemical reaction phenomena enhance at least one of the mechanical, electrical, thermal, durability and functional attributes of these contact points, which translate into improved properties of the joined article. The enhanced contact points enable effective use of the distinct qualities of nanomaterials towards development of joints which offer unique balances of strength, ductility, toughness, transport qualities, thermal stability, weathering resistance and other characteristics.

### STATEMENT REGARDING FEDERALLY SPONSORED RESEARCH & DEVELOPMENT

This invention was made with U.S. government support under Contracts FA8650-07-C-3704 by the U.S. Air Force. The U.S. government has certain rights in the invention.

### CROSS-REFERENCE RELATED TO THIS APPLICATIONS

Not applicable.

### FIELD OF INVENTION

The present invention relates to fabrication of joints between articles, where joining surfaces of said articles are linked via slender nanomaterials. The nanomaterials are linked to one another and also to the joining surfaces by at least one of fusion, embedment and chemical bonding phenomena. The joining process applies particularly to thermoplastics and composites thereof.

### BACKGROUND OF THE INVENTION

The following is a tabulation of some prior art that presently appears relevant:

| Pat. No. | Kind Code | Issue Date | Patentee |
|---|---|---|---|
| 7,651,769 | B2 | January 2010 | Dubrow |
| 7,056,409 | B2 | June 2006 | Dubrow |
| 7,074,294 | B2 | July 2006 | Dubrow |
| 7,344,617 | B2 | March 2008 | Dubrow |
| 5,151,149 | A | September 1992 | Swartz |
| 5,286,327 | A | February 1994 | Swartz |
| 3,560,291 | | February 1971 | Foglia et al. |
| 4,636,609 | | January 1987 | Nakamata |

At the most fundamental level, all joining methods rely on mechanical, chemical and/or physical forces. These forces are currently used by three principal joining methods: (i) mechanical fastening; (ii) adhesive bonding; and (iii) welding (including soldering, brazing). Joints critically influence structural performance; ineffective and inefficient joining commonly undermines the gains in performance or efficiency which would be otherwise realized with advanced materials and structural systems. The anisotropy, structural complexity and sensitivity of advanced materials (including composites) increasingly challenge conventional joining techniques.

While traditional design requirements have largely been met by conventional joining techniques, advanced materials require more elaborate joining methods. The growing variety of fundamentally different material types encourages development of hybrid structures for optimum performance. The incompatibilities in physical, chemical and mechanical properties of the materials used in hybrid structures pose new challenges to joining processes. Modern designs push advanced materials and structures to new limits, challenging the capabilities of traditional joining methods. Many advanced materials are also inherently sensitive to secondary processing during manufacturing; their microstructure and properties can thus be compromised during joining. Further demands for new, improved joining methods are created by the growing emphasis on multi-functional structures, automated manufacturing techniques, nondestructive evaluation (for quality assurance and health monitoring), and environmentally friendly practices.

Assemblies of slender nanomaterials in the form of mats of randomly oriented nanomaterials or more organized arrays of nanomaterials offer desirable conformability and morphology to establish high concentrations of contact points once pressed against each other or against surfaces with different roughness characteristics. The current invention relies on enhancing the adhesion capacity of contact points through at least one of fusion, embedment and chemical reaction phenomena involving the contacting surfaces. In another aspect, the invention provides joints comprising an assembly of nanomaterials at the interface of two parts, with contact points improved by at least one of fusion, embedment and chemical reaction phenomena, with said joint offering desired combinations of physical, mechanical, durability, transport and functional qualities which reflect upon those of the selected nanomaterials as well as their arrangement in the joint.

In one aspect, the invention is directed to developing high-performance joints between different parts using assemblies of slender nanomaterials which interface said parts. In another aspect, the invention provides a versatile joining method which can be used between different materials, and can render desirable combinations of mechanical, physical, durability, transport and functional characteristics.

In U.S. Pat. No. 7,651,769; U.S. Pat. No. 7,056,409; U.S. Pat. No. 7,074,294; and U.S. Pat. No. 7,344,617, nanofibers are disposed between joining surfaces of two articles in order to join them by the van der Waals attractions that develop at the contact points between nanofibers and the surface. The reliance on the relatively weak van der waals interactions is one limiting factor which compromises the adhesion capacity that can be realized using this approach. Another setback relates to the limited molecular-scale interactions that can be established between the solid tips or walls of nanofibers and the surface, when compared with the more thorough molecular-scale interactions of liquid adhesives. This limitation further compromises the potential for achieving high adhesion capacities using this approach. The examples included in these patents provide adhesion capacities that are three orders of magnitude (one thousand times) less than those commonly provided by adhesives. The present invention improves the adhesion capacity beyond that realized by van der Waals interactions, using fusion, embedment and/or chemical reaction phenomena involving nanomaterials introduced at the interface between the joining surfaces. The present invention also improves the adhesion capacity between nanomaterials by fusion and/or chemical reaction at their contact points.

The U.S. Pat. No. 5,151,149 and U.S. Pat. No. 5,286,327 disclose plastic joining techniques through heating with infrared energy to locally melt the plastic surfaces followed by pressing to form the joints. U.S. Pat. No. 3,560,291 and U.S. Pat. No. 4,636,609 developed a method of joining thermoplastic resin films using laser focus beam. These inventions rely on physical attractions and different secondary interactions in bond formation, which are much weaker than covalent chemical bonds.

The present invention is distinguished from these prior inventions by improving the adhesion capacity beyond that realized by van der Waals interactions, using fusion, embedment and/or chemical reaction phenomena involving nanomaterials introduced at the interface between the joining surfaces. The present invention also improves the adhesion capacity between nanomaterials by fusion and/or chemical reaction at their contact points.

### SUMMARY OF THE INVENTION

The present invention employs slender nanomaterials to join different articles in order to form shaped articles. The resulting shaped articles comprise at least two articles which are joined together at their contact surfaces, with at least one randomly oriented mat of nanomaterials introduced at each contact surface, and the contacts between nanomaterials and the article surfaces enhanced by at least one of embedment, fusion, and chemical reaction phenomena. The high surface area of nanomaterials generates large contact densities within nanomaterials and also between nanomaterials and the joined surfaces of articles. The embedment, fusion and chemical reaction phenomena occurring at contact points of nanomaterials enhances at least one of mechanical qualities and transport attributes at the contact points. The improved contact points enable effective use of the distinct qualities of nanomaterials towards development of joints between articles which provide desired strength, deformation capacity, toughness, thermal stability, weathering resistance, electrical and thermal conductivity, and other characteristics. The embedment, fusion and chemical reaction phenomena at contact points can be induced by at least one of microwave irradiation and induction heating of the whole assembly of the two articles with nanomaterials at their interface.

### BRIEF DESCRIPTION OF THE SEVERAL VIEWS OF THE DRAWINGS

FIG. 1 shows an implementation of the approach to fabrication of nano-engineered joints, depicting the fabrication steps and a nano-engineered joint. This joint comprises two articles joined via nanomaterials which are introduced at their interface, with nanomaterials anchored at their contact points with the joining surfaces. These nano-engineered joints could also benefit from bond formation at nanomaterial-to-nanomaterial contacts.

FIG. 2 shows a nano-engineered joint comprising two joined surfaces and an array of nanomaterials at the interface, with nanomaterials anchored to the joining surfaces at their contact points, and bonds formed at nanomaterial-to-nanomaterial contacts.

FIG. 3 shows pictures of the solvent, a dispersion of nanotubes in solvent, a control thermoplastic plate (prior to deposition of nanotubes on its surface), and thermoplastic plates with nanotube mats deposited on their joining surfaces via solvent-casting.

FIG. 4 shows a scanning electron microscope image (top view) of a carbon nanotube mat deposited upon a thermoplastic (PET) surface.

FIG. 5 shows a scanning electron microscope image (side view) of a carbon nanotube mat deposited on a thermoplastic surface.

FIG. 6 shows typical shear load-deflection curves of nano-engineered and adhesively bonded joints.

FIG. 7 shows the quantitative measures used to evaluate the shear performance characteristics of joints.

FIG. 8 shows a scanning electron microscope (SEM) image of the nanotube mat on the failed surface of a nano-engineered joint between thermoplastic plates subjected to single-lap shear test.

FIG. 9 shows scanning electron micrograph of as produced CNT array on quartz.

FIG. 10 shows shear load-deflection curves of nano-engineered fabricated with CNT array and adhesively bonded joints.

FIG. 11 shows a comparison of shear load-deflection behavior observed for thermoplastic composite joints with randomly oriented CNT mat at the joining interface, and control joints fabricated through heating without introduction of CNT.

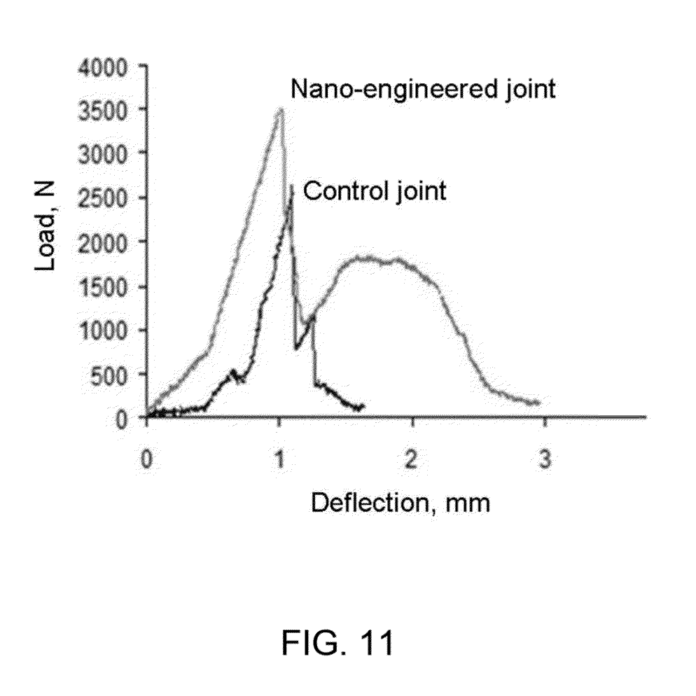

FIG. 12 shows a picture of the PET plates prior to solvent casting of the metal coated nanotube dispersion, and PET plates with metal coated CNT.

FIG. 13 shows visual appearance of nano-engineered joints fabricated with metal coated carbon nanotubes after failure in shear.

FIG. 14 shows the intact nano-engineered joint after shear failure.

### DETAILED DESCRIPTION OF THE INVENTION

Joining of similar or dissimilar materials to provide for transfer of stress, temperature and electricity between said materials is a generally required step when parts are assembled to form systems. Joining can be accomplished by adhesive bonding, welding (including soldering and brazing), diffusion bonding, and mechanical fastening. Major advances in development of advanced materials has necessitated development of more elaborate joining techniques. Some challenges associated with joining of advanced materials include: (i) the diversity of material types, and growing use of combinations of materials rather than a single material in production of systems; (ii) increasingly multifunctional roles of advanced materials, requiring transfer of stress, electricity and/or heat across joints; (iii) the growing need for the stability of the joint performance in hostile environments; and (iv) the need for use of milder joining conditions in order to avoid damage to advanced materials, and accommodate their anisotropic behavior. The demands for new, improved joining techniques are further grown by the need for environmentally friendly and energy-efficient joining practices, and also by the emphasis on nondestructive evaluation for quality assurance and health monitoring of systems. In spite of these challenges, joining has not fundamentally changed over decades.

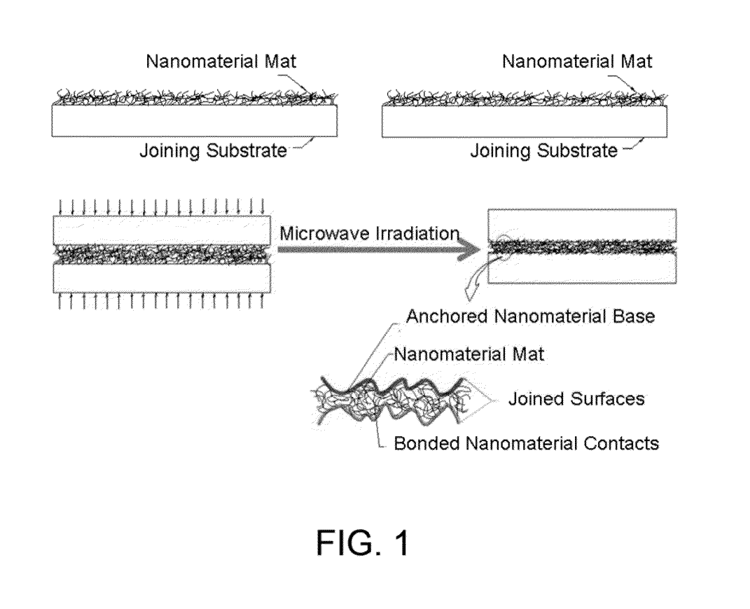

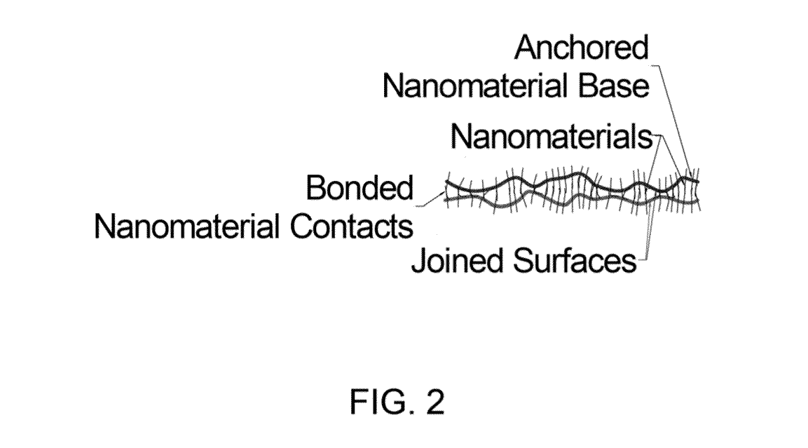

A new, versatile class of joints has been developed, where a massive number of nanomaterials (nanotubes, nanowires, etc.) are introduced, in the form of arrays or mats of nanomaterials, at the interface between the contacting surfaces of joined components, with the nanomaterials anchored to said surfaces via at least one of embedment and bonding mechanisms. A schematic depiction of this new class of joints is presented in FIG. 1. The nanomaterials interfacing the joined surfaces are anchored onto said surfaces via at least one of embedment, diffusion bonding, fusion, and chemical and physical bonding. The contact points between nanomaterials within the interface are bonded via at least one of diffusion bonding, fusion, chemical and physical bonding. The joint shown in FIG. 1 incorporates nanomaterials that are randomly oriented. As shown in FIG. 2, nanomaterials can also be perpendicular to the joined surfaces. In both joint configurations shown in FIG. 1 and FIG. 2, the nanomaterials are anchored at their base onto the joined surfaces, and their contact points within their interfaces are bonded together.

Examples of nanomaterials interfacing the joined surfaces include single-walled and multi-walled carbon nanotubes, copper-coated single- and multi-walled carbon nanotubes, carbon nanofibers, copper-coated carbon nanofibers, graphite nanoplatelets, and other metal and polymer nanotubes, nanowires and nanofibers. Examples of nanomaterial-to-joining surface contact (anchorage) mechanisms include diffusion bonding of copper-coated carbon nanotubes and copper nanowires with metallic surfaces, partial embedment of carbon nanotubes and other nanomaterials into locally melted thermoplastic or thermoplastic composite surfaces followed by solidification of the locally melted areas, and development of linkages via molten media which wet the nanomaterials and joining surfaces and, upon solidification, bond them together. The energy input required for nanomaterial-to-nanomaterial and nanomaterial-to-surface bonding via these mechanisms can be provided by at least one of microwave irradiation, convective heating, conductive heating, Joule heating, and inductive heating.

The unique qualities and broad selections of nanomaterials together with the modified nanomaterial-to-nanomaterial and nanomaterial-to-surface contact points provide nano-engineered joints with the ability to meet diverse performance requirements concerning the strength, ductility, toughness, deformation capacity, impact resistance, conformability, thermo-mechanical stability, durability, fatigue life, conductivity, and other qualities of joints used in diverse fields of application. Nano-engineered joints can be formed between diverse material systems, including polymers, ceramics, and their composites. Given the versatility of the nanomaterial selections, joined surfaces, and methods of modifying nanomaterial-to-nanomaterial and nanomaterial-to-surface contact points, nano-engineered joints can compete with broad categories of joining techniques in different applications.

The present invention may be further understood from the processing and characterization work described in the examples below.

### INVENTION AND COMPARISON EXAMPLES

### Example 1

### Introduction

Nano-engineered joints were formed between thermoplastic substrates by depositing multi-walled carbon nanotube mats on the joining surfaces of two thermoplastic surfaces, pressing the two joining surfaces covered with nanotube mats against each other, and microwave irradiation of the assembly in order to heat the nanotubes. The high absorption of microwave energy by carbon nanotubes elevated their temperature, and locally melted the thermoplastic surfaces at the nanotube-to-surface contact points. Nanotubes were partially embedded into the locally molten surfaces at nanotube-to-surface contacts. Heating of nanotubes also caused fusion of the nanotube-to-nanotube contacts. FIG. 1 schematically depicts the nano-engineered joint fabrication process, Starting with introduction of randomly oriented mats on thermoplastic surfaces.

### Experimental Materials

Polyethylene terephthalate (PET) plates with thickness of 6 mm were the substrates used in the experimental work. Deionized (DI) water, N,N Dimethylformamaide (DMF, Reagent Plus 99%) and ethanol were used as solvents. A concentrated cleaning solution, Micro-90, was used for cleaning of joining surfaces. Multi-walled, carboxylic acid (COOH) functionalized carbon nanotubes with 15±5 nm diameter, and 5 to 20 μm length, dispersed in DMF (2 mg/mL), were the nanomaterials used for production of nano-engineered joints between thermoplastic surfaces. A commercially available high-performance adhesive was used for preparation of control joints.

### Preparation of Joining Surfaces, and Deposition of Nanotube Mats

The PET plates were sonicated for 15 minutes in the cleaning solution, rinsed thoroughly with deionized water, and sonicated for 15 minutes in DI water. The plates were further sonicated for 15 minutes in ethanol, and then air-dried: Finally, the plates were subjected to UV/ozone treatment for 15 minutes just prior to the deposition of CNT dispersion in water.

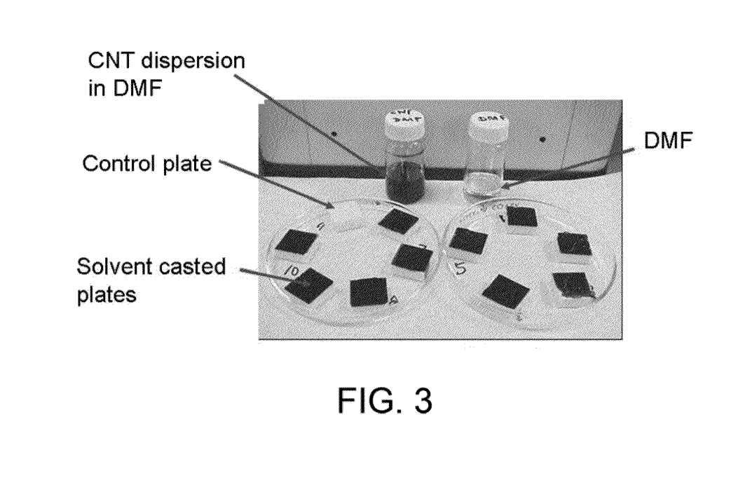

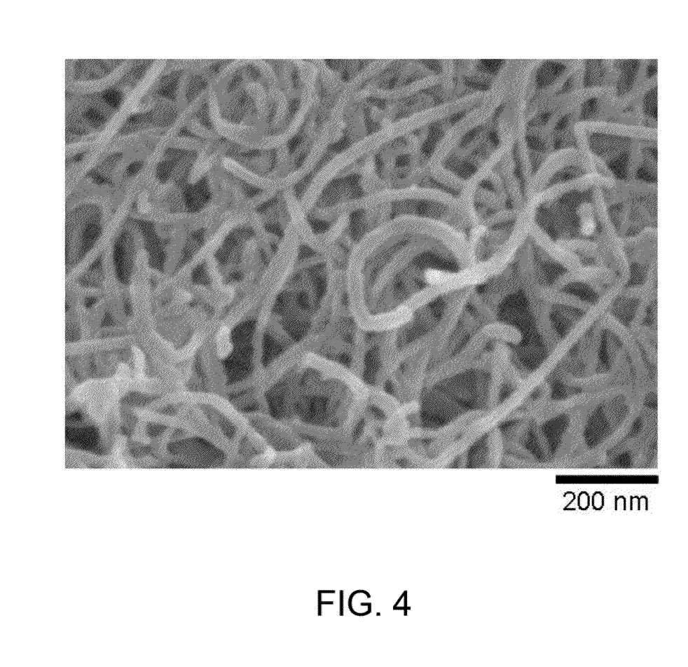

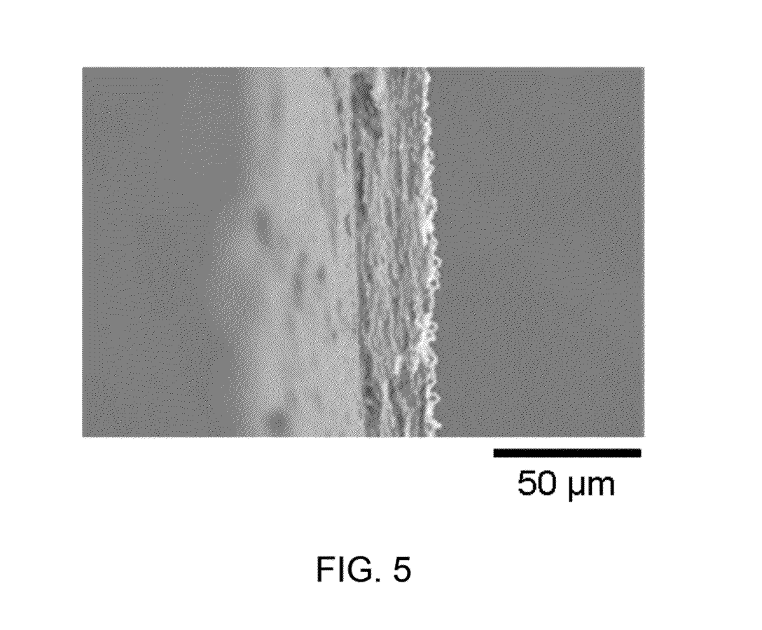

Carbon nanotube mats were introduced upon the cleaned PET substrates by solvent-casting. This procedure involves casting (which can be accomplished by drop-wise introduction) of well-dispersed nanotubes (in DMF or water) on the PET surface, and allowing the solvent to evaporate. During evaporation of the solvent, nanotubes slowly deposit on the surface, developing intimate contacts with the surface and also between nanotubes. The orientation of nanotubes within the resulting mat tends to be random; there is also a tendency for nanotubes to assume a flat (2D) orientation near the substrate surface for maximizing their bonding potential. The evaporation of solvent can be accelerated using heat and/or vacuum. FIG. 3 shows pictures of the solvent (DMF), nanotube dispersion in DMF, a PET Plate prior to solvent-casting of nanotubes, and solvent-cast nanotube mats on different PET plates. FIG. 4 shows a scanning electron microscope image (top view) of a nanotube mat deposited upon a PET surface. FIG. 5 shows a scanning electron microscope image (side view) of a deposited nanotube mat on a PET surface at relatively low magnification, which can be used to assess the thickness of the nanotube mat. With 15, 30 and 45 nanotube layers deposited, the resulting nanotube mat thickness was about 5, 10 and 15 micrometer.

### Joint Formation by Microwave Irradiation

PET surfaces with solvent-cast nanotube mats were pressed against each other, sandwiched between alumina plates, and clamped in a polypropylene mold which used bolts to apply about 50 KPa pressure on the joint area. Alumina plates and polypropylene molds were used here because of their negligible microwave absorption; most of the microwave energy would thus reach the carbon nanotube mat. The whole set-up was placed in a vacuum chamber within a microwave oven, and irradiate for 1 minute.

### Production of Control Adhesively-Bonded Joints

Control (adhesively bonded) joints were prepared between PET plates using a high-performance adhesive, which is a methacrylate-based structural adhesive formulated to bond almost all engineered thermoplastics, thermosets, composites, and metal structural elements. The adhesively bonded joints were subjected to one week of curing at room temperature prior to evaluation of their performance characteristics.

### Evaluation of the Joint Performance

The low-temperature nano-engineered (and control adhesively bonded) joints were subjected to single-lap shear, fatigue, temperature-cycle, and durability tests. The test procedures and the experimental results are presented in the following section.

### Single-Lap Shear Tests

Single-lap shear tests were performed on 20 mm×20 mm joint areas processed via microwave irradiation. Both nano-engineered and control (adhesively bonded) joints formed between PET plates were subjected to single-lap shear tests. Nano-engineered joints with smaller nanotube mat thickness (about 5 micrometer) produced the highest strengths.

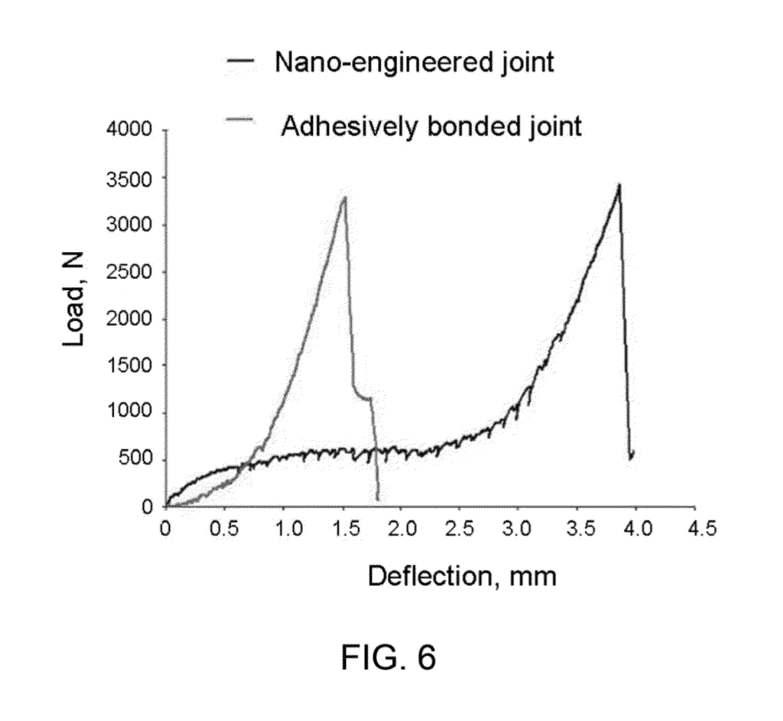

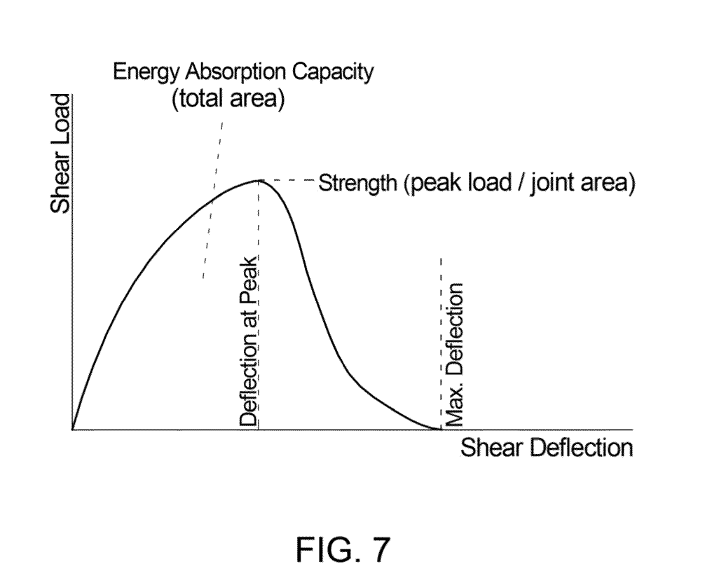

Typical shear load-deflection curves obtained for nano-engineered and adhesively bonded joints are presented in FIG. 6, where the nano-engineered joint is observed to provide substantially improved ductility (deformation capacity) and toughness (energy absorption capacity) together with increased strength. Quantitative measures of the joint shear performance are presented in FIG. 7. An evaluation of replicated single-lap shear tests are presented in the following.

Twenty five nano-engineered joints and twenty five adhesively bonded joints were subjected to single-lap shear tests. The mean values of shear strengths were 13.6 MPa and 11.6 MPa for nano-engineered joints and adhesively bonded joints, respectively; the standard errors of shear strengths for both categories of joints were 16% of the corresponding mean values. The mean values of maximum deflection were 3.0 mm and 1.5 mm for nano-engineered joints and adhesively bonded joints, respectively, with the corresponding standard errors (expressed as percentages of mean) of 37% and 53%, respectively.

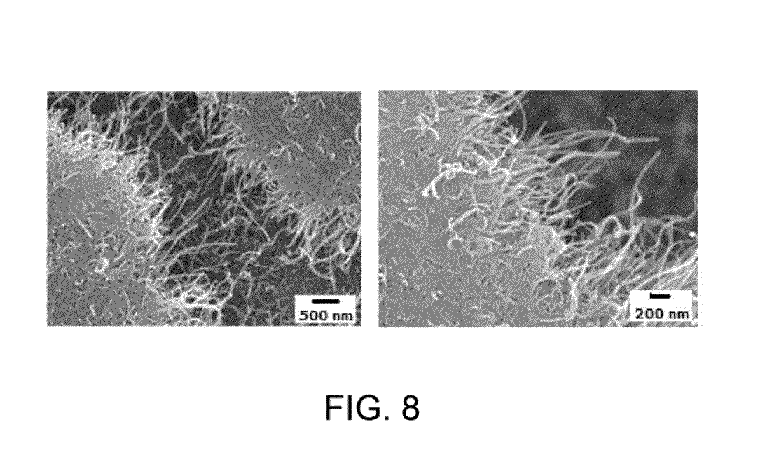

While failure through the nanotube mat was commonly observed in shear tests on nano-engineered joints, some of these joints experienced a combination failure through the nanotube mat and the substrates. The high ductility of nano-engineered joints led to failure conditions where some joints remained intact after performance of shear tests up to relatively large deformations. Scanning electron microscope images of the failed surfaces of a nano-engineered joint are presented in FIG. 8. These images were captured from areas where failure occurred through the nanotube mat, and exhibit the intermingled and integrated structure of the nanotube mat after production of nano-engineered joints.

### Fatigue Tests

Nano-engineered and adhesively bonded joints were subjected to repeated application of 70% of their corresponding single-lap shear strength, and then unloaded. The number of cycle to failure was recorded in each fatigue test. The mean number of cycles to fatigue failure was 230,090 for nano-engineered joints, and 131,414 for adhesively bonded joints.

### Temperature Cycle Tests

Joint specimens were placed on a cold plate with a constant temperature of −8° C., with the opposite face subjected to repeated temperature cycles of 60° C. for 30 minutes and room temperature for 30 minutes; the test was continued over a total period of 120 hours. This process subjected the joint to repeated thermo-mechanical stress cycles. In order to determine the damage caused by these stress cycles, the joints were subjected to single-lap shear tests after exposure to temperature cycles, and their shear strengths were compared with those obtained with similarly produced joints tested prior to exposure to any temperature cycles. Seven nano-engineered and seven adhesively bonded joints were evaluated in this experimental program. Nano-engineered joints retained 93% of their original mean shear strength after exposure to temperature cycles, while adhesively bonded joints retained only 51% of their original mean shear strength after exposure to temperature cycles.

### Example 2

### Introduction

Nano-engineered joints were formed between two thermoplastic plates through an aligned array of carbon nanotubes introduced upon one of the joining surfaces. Two joining surfaces were pressed against each other, and exposed to microwave irradiation over a short duration. Microwave irradiation led to partial embedment of the nanotube mat into the joining surfaces through locally heating and melting the nanotube-to-surface contact points. Upon cooling and release of the applied pressure, a strong joint was established between the two thermoplastic plates.

### Experimental Materials

Multi-walled carbon nanotube arrays grown on quartz were used. The carbon nanotube length and diameter in the array were 200 micrometer and 10 nanometer, respectively. The surface density of nanotubes was 10¹⁴ to 10¹⁵ per square meter. Same thermoplastic substrates as in Example 1 were used for transfer of the CNT array and subsequent joint formation.

### Methods

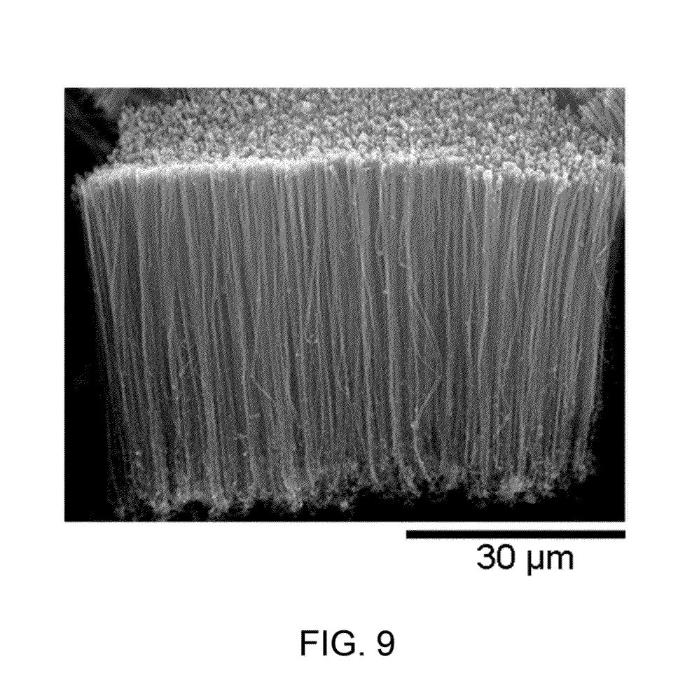

Thermoplastic plates were cleaned following the procedures described in Example 1. Aligned carbon nanotube arrays grown on quartz substrates (FIG. 9) were pressed against thermoplastic plates, and subjected to a minimum pressure of 30 KPa. The assembly was subjected to microwave irradiation (1100 W power, 2.5 GHz) for 5 seconds, with water present in the microwave.

Subsequent pulling of the quartz sheet from the thermoplastic sheet led to transfer of the carbon nanotube array to the thermoplastic surface (due to embedment of the nanotube tips in the thermoplastic sheet upon microwave irradiation). The microwave irradiation conditions used here allowed for transfer of about 90% of the nanotubes in array to the thermoplastic sheet.

The thermoplastic plate with carbon nanotube array was then pressed against another thermoplastic plate, sandwiched between alumina plates, and clamped in a polypropylene mold which used bolts to apply about 50 KPa pressure on the joint area. Alumina and polypropylene were used here because of their negligible microwave absorption; most of microwave energy would thus reach the carbon nanotube array. The whole set-up was placed in a vacuum chamber within a microwave oven, and irradiate for 1 to 2 minutes.

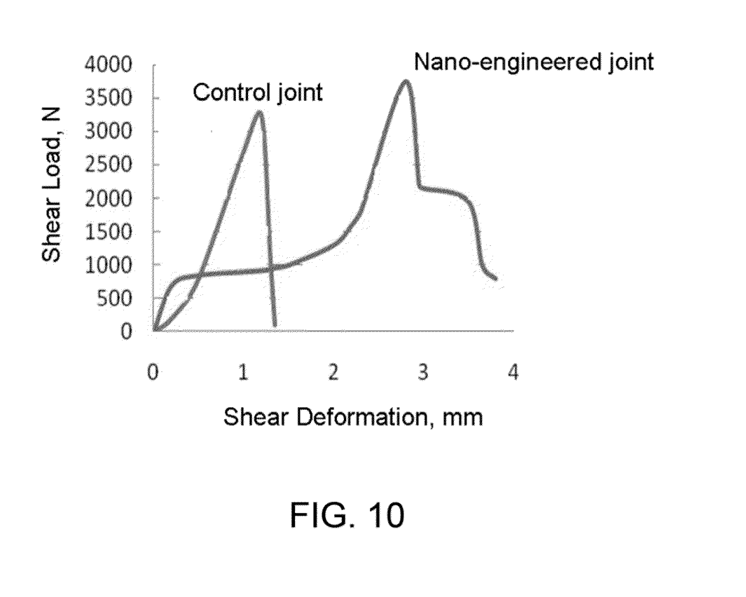

The resulting joints with 20 mm×20 mm interface (joint surface) area were subjected to single-lap shear tests in a displacement-controlled test test system operated at a (quasi-static) displacement rate of 0.002 mm/sec. When compared with the joint with solvent-cast nanotube mat at the interface, this joint made using aligned nanotube array offered desired ductility; its strength, however, was somewhat low. The shear load-deflection behavior of this joint is presented in FIG. 10.

### Example 3

### Introduction

Nano-engineered joints were formed between fiber reinforced thermoplastic matrix composites. Multiwalled carbon nanotubes were introduced at the joining surfaces of thermoplastic composites. These surfaces were then pressed against each other, and exposed to microwave irradiation to locally embed the nanotubes at their contact points with joining surfaces, and to enhance the nanotube-to-nanotube contacts. The shear performance of nano-engineered joints exhibited improvements over joints prepared similarly but without introduction of nanotubes on joining surfaces. These control joints are referred to as welded (fusion bonded) joints, which are formed by heating and melting of the thermoplastic polymer on the joining surfaces pressed against each other, with the joint formed upon cooling (solidification). In the presence of carbon nanotubes at the interface, the molten thermoplastic partially embeds (anchors) nanotubes at their contacts with the joining surfaces. In addition, the microwave heating can induce chemical bonding of the carboxylic acid groups on contacting nanotube walls, producing a cross-linked nanotube mat with improved mechanical and physical performance.

### Materials and Experimental Methods

The thermoplastic matrix composite used in this example was glass fiber reinforced polypropylene in the form of 6 mm thick plates, comprising a thermoplastic polypropylene matrix with unidirectional glass fiber reinforcement. The carbon nanotubes used in this example were multiwalled, carboxyl acid (COOH) functionalized carbon nanotubes with 15±5 nm diameter and 5-20 μm length, dispersed in DMF solvent at a concentration of 2 mg/mL (or alternatively in water at a concentration of 3 mg/mL).

In order to clean the joining surfaces, the composite plates were sonicated for 15 minutes in cleaning solution, rinsed thoroughly with deionized water, and further sonicated for 15 minutes in deionized water. The plates were then air-dried, and subjected to UV/ozone treatment for 15 minutes just prior to deposition of carbon nanotubes.

A simple solvent-casting procedure was employed to introduce a nanotube mat on joining surfaces. This process comprised repeated implementation of two steps: (i) introduction of the nanotube dispersion in DMF on the joining surface by drop casting; and (ii) evaporation of the solvent on a hot plate (heated to 65° C.). These two steps were repeated until the targeted nanotube mat thickness was achieved.

For the purpose of joint formation, the composite plates were pressed each other with the deposited nanotube mats facing each other, and were subjected to microwave irradiation for desired time. The control joints were prepared by heating in an oven instead of microwave irradiation and without having nanotube mats.

The resulting joints with 20 mm×20 mm interface (joint surface) area were subjected to single-lap shear tests in a displacement-controlled test machine operated at a (quasi-static) displacement rate of 0.002 mm/sec. The average shear strength, maximum deflection, and energy absorption capacity (to failure) of these control joints were 6.25 MPa, 1.8 mm and 0.85 J, respectively. Ten nano-engineered joints were also produced and tested, using a nanotube mat thickness introduced on each joining surface of 1.6 micrometer. The average shear strength, maximum deflection and energy absorption capacity (to failure) of these nano-engineered joints were 8.2 MPa, 2.2 mm and 2.4 J, respectively. Introduction of carbon nanotubes thus led to important gains in shear strength (31%), maximum deflection at failure (22%), and energy absorption to failure (182%).

### Example 4

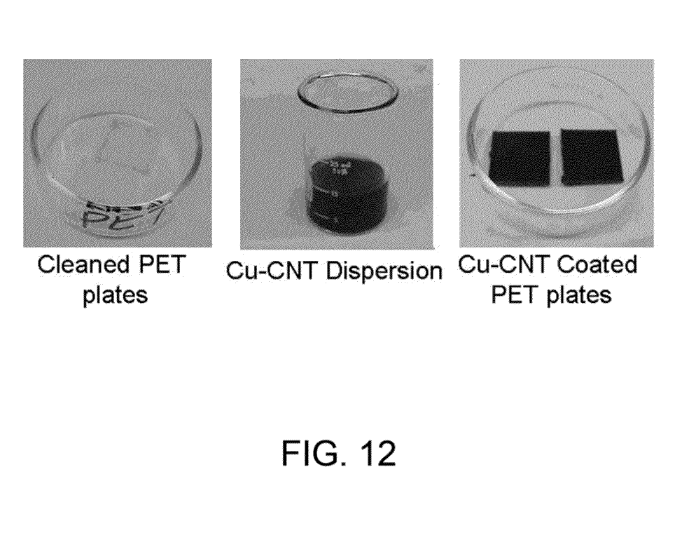

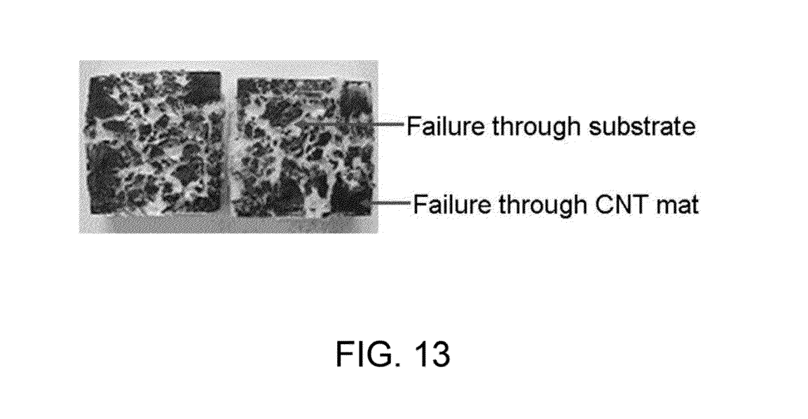

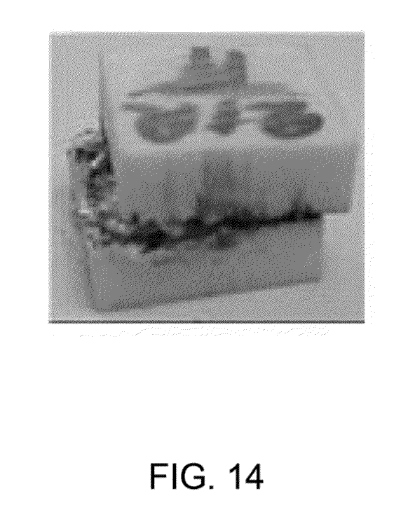

Metal (nickel or copper) coated multi-walled carbon nanotube mats were introduced on thermoplastic substrates through solvent casting (FIG. 12). The coated surfaces were then pressed against each other, and subjected to microwave irradiation as described in Example 1. Upon exposure to microwave irradiation, metal coated carbon nanotubes absorb microwave energy, leading to: (i) partial embedment of nanotubes at nanotube-to-surface contacts by local melting of thermoplastic surfaces; and (ii) fusion of nanotubes at nanotube-to-nanotube contacts due to local heating of the metal coatings on nanotubes. The shear, tension and impact performance attributes of the joints made between PET substrates with fused metal coated carbon nanotube mat at the interface were assessed against the corresponding performance attributes of comparable joints made with a high-performance adhesive. The joints with fused metal coated nanotube mat exhibited superior performance characteristics when compared with joints made with high-performance adhesive under shear and particularly tension and impact loads. While failure through the nanotube mat was commonly observed in shear tests, some joints also experienced a combination failure through the nanotube mat and the substrates (FIG. 13). The ductility of nano-engineered joints enables some joints remain intact after the performance of shear test (FIG. 14).

What is claimed is:

1. A method of joining two or more articles made of at least one of thermoplastics and thermoplastic matrix composites, the method comprising:
(i) introducing a plurality of nanomaterials on joining surfaces of at least one of said articles;
(ii) establishing contact between said joining surfaces by pressing the articles against each other with said nanomaterials sandwiched between the joining surfaces;
(iii) energizing said nanomaterials by electromagnetic radiation at wavelengths that are strongly absorbed by the nanomaterials, but are not strongly reflected or absorbed by said articles, in order to heat the nanomaterials to locally melt the joining surfaces of said articles in the vicinity of the nanomaterials, and partially embed said nanomaterials into the locally molten surfaces of said articles;
(iv) cooling said contacting articles to solidify said locally molten surfaces in order to form a joint between said articles via partially embedded nanomaterials which link said joining surfaces.

2. The method of claim 1, wherein said articles are made of thermoplastics comprising at least one of polyamide, polyetheretherketone, polyethersulfone, polysulfone, polyethylene trepthalate, polypropylene, polycarbonate and nylon.

3. The method of claim 1, wherein said articles are made of thermoplastic matrix composites comprising at least one of polyamide, polyetheretherketone, polyethersulfone, polysulfone, polyethylene trepthalate, polycarbonate, nylon and polypropylene matrices reinforced with at least one of glass, basalt, polyethylene, cellulose and aramid fibers in at least one of continuous and discrete forms.

4. The method of claim 1, wherein the nanomaterials are at least one of nanofibers, nanotubes, nanoparticles and nanoplatelets.

5. The method of claim 1, wherein said nanomaterials are made of carbon, and can directly couple with electromagnetic energy in microwave frequencies ranging from 300 MHz to 300 GHz through molecular interactions to cause local temperature rise within and in the vicinity of said nanomaterials.

6. The method of claim 1, wherein said nanomaterials are introduced in the form of mats comprising randomly oriented nanomaterials.

7. The method in claim 6, wherein said nanomaterials are dispersed in at least one of water and organic solvents, and introduced on the joining surfaces of at least one of said articles by at least one of solvent-casting, spraying and self-assembly techniques.

8. The method of claim 1, wherein said nanomaterials are introduced in the form of arrays comprising aligned nanomaterials.

9. The method of claim 1, wherein the surfaces of said nanomaterials are modified chemically by introducing functional groups.

10. The method of claim 9, wherein said functional groups are at least one of hydroxyl and carboxyl groups.

11. The method of claim 1, wherein surfaces of said nanomaterials are modified by coating using at least one of electroless deposition and electrodeposition techniques.

12. The method of claim 11, wherein said coating is made of at least one of copper, nickel and silver.
